(19) United States
(12) Patent Application Publication
(10) Pub. No.: US 2015/0127880 A1
(43) Pub. Date: May 7, 2015

(54) EFFICIENT IMPLEMENTATIONS FOR MAPREDUCE SYSTEMS

(71) Applicant: Cognitive Electronics, Inc., Boston, MA (US)

(72) Inventor: Andrew C. Felch, Palo Alto, CA (US)

(73) Assignee: Cognitive Electronics, Inc., Boston, MA (US)

(21) Appl. No.: 14/530,404

(22) Filed: Oct. 31, 2014

Related U.S. Application Data
(60) Provisional application No. 61/898,942, filed on Nov. 1, 2013.

(51) Int. Cl. G06F 12/10; G06F 12/06; G06F 12/02

(52) U.S. Cl. CPC G06F 12/1018; G06F 12/0238; G06F 12/0638; G06F 2212/205
USPC 711/102; 711/153

(57) ABSTRACT

Techniques for use with a processor configured to function as at least a Mapper in a MapReduce system include generating a set of [key, value] pairs by executing a Map function on input data. The set of [key, value] pairs may be stored in a storage system implemented on at least one data storage medium, the storage system being organized into a plurality of divisions with different divisions of the storage system storing [key, value] pairs corresponding to different keys. A first [key, value] pair corresponding to a first key handled by a first Reducer in the MapReduce system and a second [key, value] pair corresponding to a second key handled by a second Reducer in the MapReduce system may both be stored in a first division of the plurality of divisions.

### CROSS-REFERENCE TO RELATED APPLICATIONS

This application claims the benefit under 35 U.S.C. §119(e) of U.S. Provisional Application Ser. No. 61/898,942, filed on Nov. 1, 2013, and entitled “Efficient and Scalable MapReduce Precomputation System,” which is hereby incorporated by reference in its entirety.

### BACKGROUND

Some embodiments described herein relate to techniques for implementing a MapReduce system. MapReduce systems provide a framework for parallelizing processing tasks to be performed on large data sets. The MapReduce framework assigns processing resources to function as Mappers and Reducers, which execute customizable Map functions and Reduce functions, respectively. Mappers operate in parallel to process input data according to the Map function, and Reducers operate in parallel to process Mapper output according to the Reduce function, to produce output data from the MapReduce program.

A canonical example of a MapReduce program is known as “Word Count,” and operates to count the number of appearances of each word that occurs in a set of documents. The Map function assigns each unique word as a key, and counts each appearance of each word in a portion of the input data (e.g., one or more documents in the set of documents). The input data set is divided into splits such that each Mapper counts the appearances of words in a portion of the document set, and the Mappers operate in parallel to count the word appearances in the entire data set in a distributed fashion. The data output by the Mappers is in the form of [key, value] pairs, with the key in each pair representing a particular word, and the value in each pair representing a count of one or more appearances of that word in the input data split processed by the Mapper that generated that [key, value] pair. A Shuffle stage delivers the [key, value] pairs from the Mappers to the Reducers, with each Reducer being responsible for a particular set of keys (i.e., a particular subset of words out of the total set of unique words that occur in the input document set), and the Reducers operating in parallel to compute the total counts of all the words in the data set in a distributed fashion. The Reduce function sums the values received from all of the Mappers for a particular key, outputting the sum as the total count of appearances of that particular word in the input document set. The output data from all of the Reducers, organized by key, thus contains a total count of appearances of each unique word in the input data set.

### SUMMARY

One type of embodiment is directed to apparatus comprising at least one processor configured to execute one or more MapReduce applications that cause the at least one processor to function as at least a Mapper in a MapReduce system, and at least one processor-readable storage medium storing processor-executable instructions that, when executed by the at least one processor, cause the at least one processor to perform a method comprising: accessing data stored in a file system implemented on at least one nonvolatile storage medium; and in response to input data being written to the file system by an application other than the one or more MapReduce applications, accessing a set of one or more Map functions applicable to the input data, executing at least one Map function of the one or more Map functions on the input data, and outputting at least one set of [key, value] pairs resulting from execution of the at least one Map function on the received input data.

Another type of embodiment is directed to a method for use with at least one processor configured to execute one or more MapReduce applications that cause the at least one processor to function as at least a Mapper in a MapReduce system, the method comprising: accessing data stored in a file system implemented on at least one nonvolatile storage medium; and in response to input data being written to the file system by an application other than the one or more MapReduce applications, accessing a set of one or more Map functions applicable to the input data, executing, via the at least one processor functioning as at least the Mapper in the MapReduce system, at least one Map function of the one or more Map functions on the input data, and outputting at least one set of [key, value] pairs resulting from execution of the at least one Map function on the received input data.

Another type of embodiment is directed to at least one processor-readable storage medium storing processor-executable instructions that, when executed, perform a method for use with at least one processor configured to execute one or more MapReduce applications that cause the at least one processor to function as at least a Mapper in a MapReduce system, the method comprising: accessing data stored in a file system implemented on at least one nonvolatile storage medium; and in response to input data being written to the file system by an application other than the one or more MapReduce applications, accessing a set of one or more Map functions applicable to the input data, executing, via the at least one processor functioning as at least the Mapper in the MapReduce system, at least one Map function of the one or more Map functions on the input data, and outputting at least one set of [key, value] pairs resulting from execution of the at least one Map function on the received input data.

Another type of embodiment is directed to apparatus comprising a processor configured to function as at least a Mapper in a MapReduce system, and a processor-readable storage medium storing processor-executable instructions that, when executed by the processor, cause the processor to perform a method comprising: generating a set of [key, value] pairs by executing a Map function on input data; and storing the set of [key, value] pairs in a storage system implemented on at least one data storage medium, the storage system being organized into a plurality of divisions with different divisions of the storage system storing [key, value] pairs corresponding to different keys, the storing comprising storing in a first division of the plurality of divisions both a first [key, value] pair corresponding to a first key handled by a first Reducer in the MapReduce system and a second [key, value] pair corresponding to a second key handled by a second Reducer in the MapReduce system.

Another type of embodiment is directed to a method comprising: generating, via a processor configured to function as at least a Mapper in a MapReduce system, a set of [key, value] pairs by executing a Map function on input data; and storing the set of [key, value] pairs in a storage system implemented on at least one data storage medium, the storage system being organized into a plurality of divisions with different divisions of the storage system storing [key, value] pairs corresponding to different keys, the storing comprising storing in a first division of the plurality of divisions both a first [key, value] pair corresponding to a first key handled by a first Reducer in the MapReduce system and a second [key, value] pair corresponding to a second key handled by a second Reducer in the MapReduce system.

Another type of embodiment is directed to at least one processor-readable storage medium storing processor-executable instructions that, when executed by a processor configured to function as at least a Mapper in a MapReduce system, perform a method comprising: generating a set of [key, value] pairs by executing a Map function on input data; and storing the set of [key, value] pairs in a storage system implemented on at least one data storage medium, the storage system being organized into a plurality of divisions with different divisions of the storage system storing [key, value] pairs corresponding to different keys, the storing comprising storing in a first division of the plurality of divisions both a first [key, value] pair corresponding to a first key handled by a first Reducer in the MapReduce system and a second [key, value] pair corresponding to a second key handled by a second Reducer in the MapReduce system.

Another type of embodiment is directed to apparatus comprising a processor configured to function as at least a first Reducer in a MapReduce system, and a processor-readable storage medium storing processor-executable instructions that, when executed by the processor, cause the processor to perform a method comprising: receiving a set of mapped [key, value] pairs output from a Mapper in the MapReduce system; identifying, within the set of mapped [key, value] pairs, one or more [key, value] pairs for whose keys the first Reducer is not responsible; and transferring the one or more identified [key, value] pairs to one or more other Reducers in the MapReduce system.

Another type of embodiment is directed to a method comprising: receiving, at a processor configured to function as at least a first Reducer in a MapReduce system, a set of mapped [key, value] pairs output from a Mapper in the MapReduce system; identifying, by the processor configured to function as at least the first Reducer, within the set of mapped [key, value] pairs, one or more [key, value] pairs for whose keys the first Reducer is not responsible; and transferring the one or more identified [key, value] pairs to one or more other Reducers in the MapReduce system.

Another type of embodiment is directed to at least one processor-readable storage medium storing processor-executable instructions that, when executed by a processor configured to function as at least a first Reducer in a MapReduce system, perform a method comprising: receiving a set of mapped [key, value] pairs output from a Mapper in the MapReduce system; identifying, within the set of mapped [key, value] pairs, one or more [key, value] pairs for whose keys the first Reducer is not responsible; and transferring the one or more identified [key, value] pairs to one or more other Reducers in the MapReduce system.

Another type of embodiment is directed to apparatus comprising at least one processor, and at least one processor-readable storage medium storing processor-executable instructions that, when executed by the at least one processor, cause the at least one processor to perform a method comprising: receiving a data packet including a set of mapped [key, value] pairs corresponding to a plurality of keys handled by a plurality of Reducers in a MapReduce system; and for each mapped [key, value] pair in the set of mapped [key, value] pairs, identifying a key corresponding to the respective mapped [key, value] pair, identifying a Reducer of the plurality of Reducers responsible for the identified key, and providing the respective mapped [key, value] pair to the identified Reducer for processing.

Another type of embodiment is directed to a method comprising: receiving, at at least one processor, a data packet including a set of mapped [key, value] pairs corresponding to a plurality of keys handled by a plurality of Reducers in a MapReduce system; and for each mapped [key, value] pair in the set of mapped [key, value] pairs, identifying, via the at least one processor, a key corresponding to the respective mapped [key, value] pair, identifying, via the at least one processor, a Reducer of the plurality of Reducers responsible for the identified key, and providing the respective mapped [key, value] pair to the identified Reducer for processing.

Another type of embodiment is directed to at least one processor-readable storage medium storing processor-executable instructions that, when executed by at least one processor, cause the at least one processor to perform a method comprising: receiving a data packet including a set of mapped [key, value] pairs corresponding to a plurality of keys handled by a plurality of Reducers in a MapReduce system; and for each mapped [key, value] pair in the set of mapped [key, value] pairs, identifying a key corresponding to the respective mapped [key, value] pair, identifying a Reducer of the plurality of Reducers responsible for the identified key, and providing the respective mapped [key, value] pair to the identified Reducer for processing.

Another type of embodiment is directed to apparatus comprising a processor configured to function as at least a Mapper in a MapReduce system, and a processor-readable storage medium storing processor-executable instructions that, when executed by the processor, cause the processor to perform a method comprising: generating mapped [key, value] pairs by executing a Map function on input data; collecting a set of the mapped [key, value] pairs corresponding to a plurality of keys handled by a plurality of Reducers in the MapReduce system; and transmitting the collected set of the mapped [key, value] pairs in a data packet to a device, local to the plurality of Reducers, responsible for routing the mapped [key, value] pairs in the data packet to the plurality of Reducers.

Another type of embodiment is directed to a method comprising: generating, via a processor configured to function as at least a Mapper in a MapReduce system, mapped [key, value] pairs by executing a Map function on input data; collecting a set of the mapped [key, value] pairs corresponding to a plurality of keys handled by a plurality of Reducers in the MapReduce system; and transmitting the collected set of the mapped [key, value] pairs in a data packet to a device, local to the plurality of Reducers, responsible for routing the mapped [key, value] pairs in the data packet to the plurality of Reducers.

Another type of embodiment is directed to at least one processor-readable storage medium storing processor-executable instructions that, when executed by a processor configured to function as at least a Mapper in a MapReduce system, perform a method comprising: generating mapped [key, value] pairs by executing a Map function on input data; collecting a set of the mapped [key, value] pairs corresponding to a plurality of keys handled by a plurality of Reducers in the MapReduce system; and transmitting the collected set of the mapped [key, value] pairs in a data packet to a device, local to the plurality of Reducers, responsible for routing the mapped [key, value] pairs in the data packet to the plurality of Reducers.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A-1C illustrate a conventional data flow in a MapReduce system;

FIG. 2 illustrates an exemplary data flow through an exemplary Mapper in accordance with some embodiments described herein;

FIG. 3 illustrates exemplary functionality of an Accelerator in accordance with some embodiments described herein;

FIG. 4 illustrates exemplary functionality of a Map Processor in accordance with some embodiments described herein;

FIG. 5 illustrates exemplary Combining functionality of a Map Processor in accordance with some embodiments described herein;

FIG. 6 illustrates exemplary functionality of Mappers and Reducers in accordance with some embodiments described herein;

FIG. 7 illustrates an exemplary method that may be performed by a Reducer in accordance with some embodiments described herein; and

FIG. 8 illustrates an exemplary computer system on which some embodiments may be implemented.

### DETAILED DESCRIPTION

### Glossary

MapReduce system, MapReduce program: As used herein, the term “MapReduce system” refers to a system implemented via hardware, software, or a combination of hardware and software, including processing resources configured to function as a set of one or more Mappers and a set of one or more Reducers. The Mappers are capable of processing data in parallel to each other, and the Reducers are capable of processing data in parallel to each other. Each Reducer is configured to process data received from the Mappers according to a customizable Reduce function, with the data organized into categories referred to as “keys.” Each Mapper is configured to process input data according to a customizable Map function, which outputs data that is paired with keys. Taken together, the Map function and the Reduce function are referred to as the “MapReduce program,” which is executed by the MapReduce system and may be user- or application-defined. In a MapReduce system with multiple Mappers, the input data to be processed by the MapReduce program is divided into portions referred to as “splits,” with each Mapper processing a different split or set of splits of the input data. In a Shuffle stage, the output data from the Mappers is distributed to the Reducers according to the keys, with different Reducers processing data corresponding to different keys. If there is a case in which a customized MapReduce program does not specify a Reduce function, then the output of the MapReduce system may be the mapped [key, value] pairs generated by the Mappers according to the specified Map function.

[End Glossary]

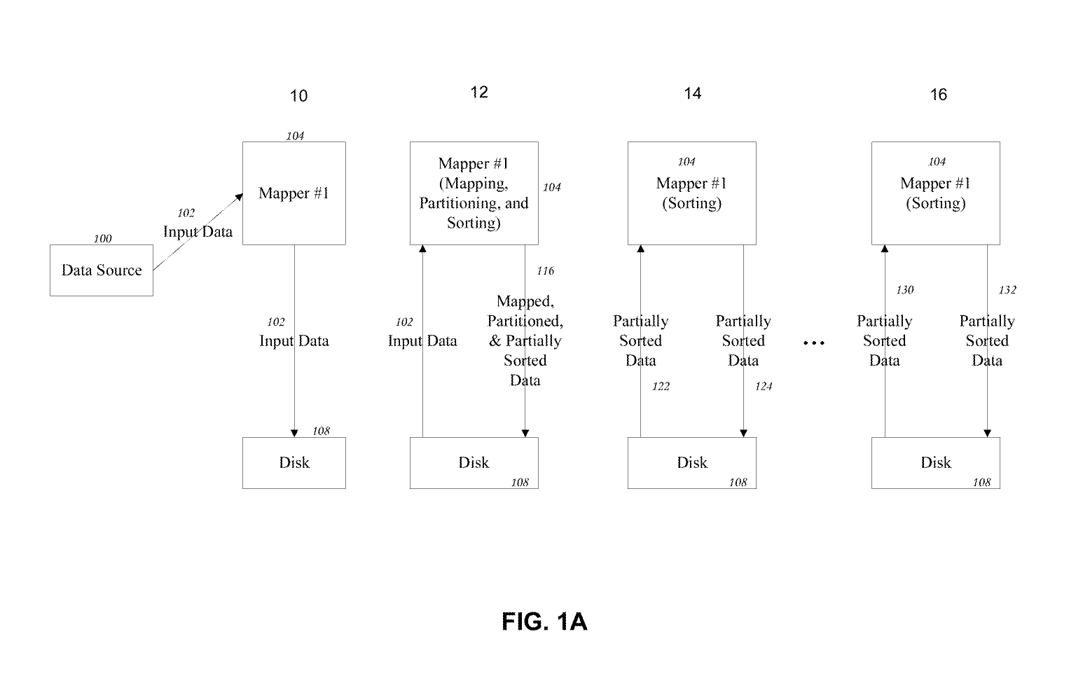

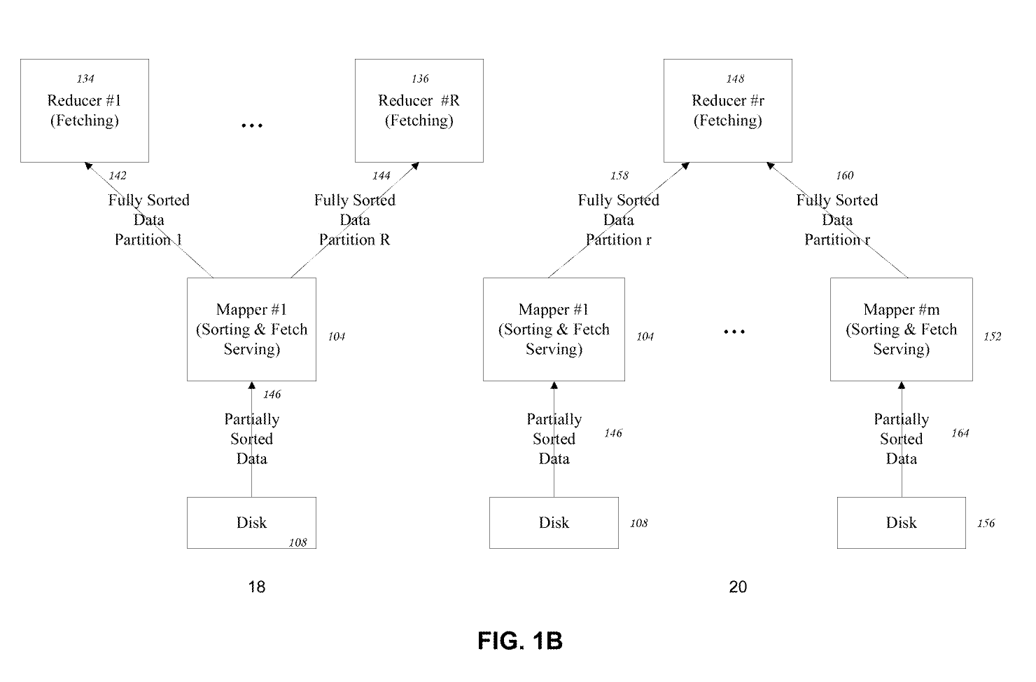

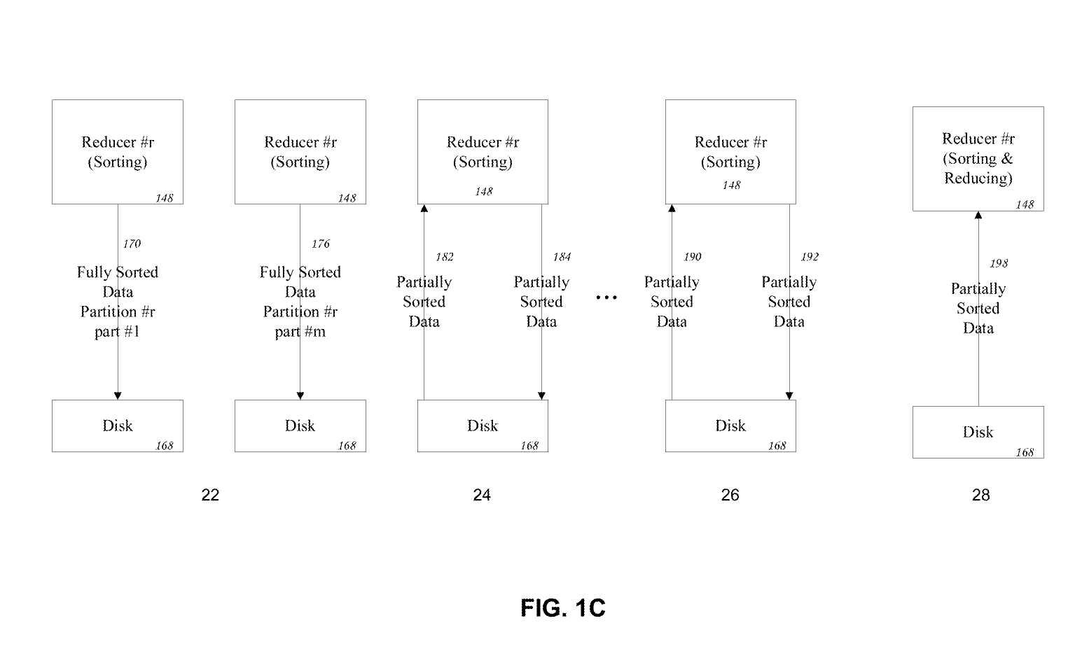

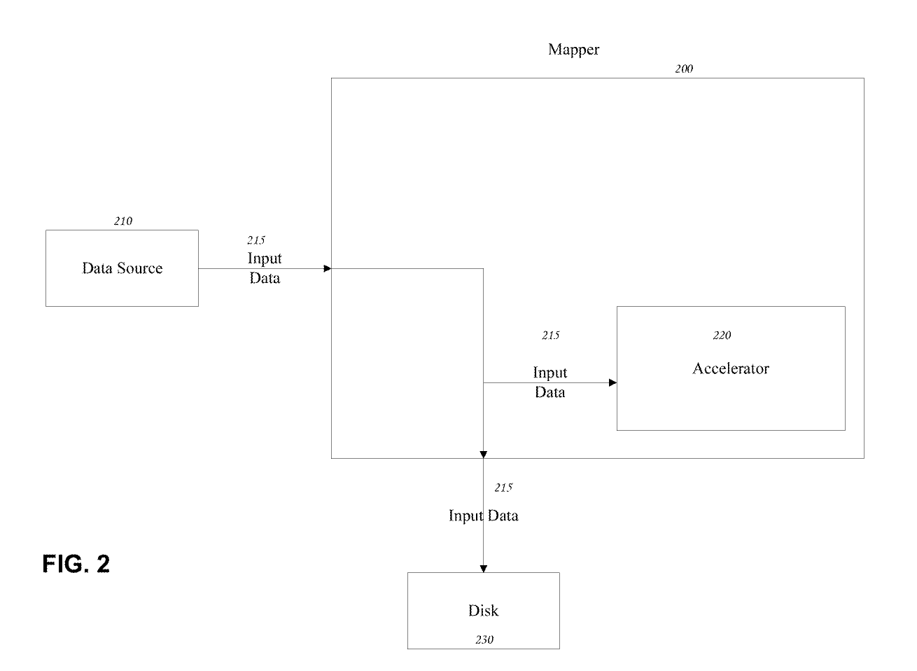

FIGS. 1A-1C depict operations in a conventional MapReduce system. In FIG. 1A, a Data Source (100) sends Input Data (102) (which may be a large data set) to Mapper #1 (104) which is the first Map Server in the example. Mapper #1 then relays this data to Disk (108) in step 10. The data source may be a camera, social media Internet stream such as Twitter's firehose, or another computer system such as a server producing information that is to be processed. The Hadoop filesystem (HDFS) depends crucially on storing the input data to MapReduce applications on disks local to the computers that will be performing the mapping operation. In a Hadoop-based system this allows each mapping server to fetch the data required to perform mapping operations directly from local disk rather than from a remote server, which is typically viewed as providing a performance advantage. The inventors have recognized that a difficulty with this configuration of MapReduce is that execution of a MapReduce program will take at least as long as the time required to read the data from disk (this shortcoming is addressed in FIG. 2). Step 110 in FIG. 1A is the first step in a multi-step example that depicts how data flows through a conventional MapReduce system such as the Apache Hadoop system.

Step 12 is a second step of the example depicted in FIG. 1A. This step proceeds once the system receives a command to perform a MapReduce program. In this step Input Data (102) that was previously stored on Disk (108) is retrieved from the Disk (108) and sent to the Mapper #1 (104) which is performing mapping, partitioning, and sorting. Mapper #1 (104) first performs an Input Split, which divides the input data into “splits” which can be processed independently. Second, each mapper process performs the Input Reader function which converts the sequence of bytes held in a given data split into a sequence of records in a format that can be processed by the Map function. In some cases, the records may comprise unstructured data such as excerpts of text from a web page or excerpts of text from a log file, which could be delimited, for example, by a particular html tag, or by end-of-line characters, etc. Third a user-defined Map function is performed on each element output by the Input Reader. These three steps are treated as all part of “mapping”.

The output of each map operation performed by the Mapper #1 (104) is a sequence of [key,value] pairs, where the key determines which Reducer will receive this [key,value] as input. These outputs are typically placed in an in-memory buffer on the Mapper (104). However, as more and more input data is processed, this buffer may approach overflow. In order to make room in the memory buffer space, the data held in the buffer must be moved. This is traditionally done by moving the data to disk. The literature may use the term “spill” or “spill to disk” to describe this emptying of the buffer by moving data held in the buffer to disk. The spilling process performs two functions to organize the data prior to its movement to disk. The first is that it is “partitioned,” which groups each [key,value] pair in a set of [key,value] pairs bound for a particular Reducer as determined by the key and the MapReduce Partition function, which may be implemented in a default manner or customized by the user. Typical MapReduce Partition functions assign each key to a single Reducer, with each Reducer being assigned multiple keys. Some embodiments described below may be useful for MapReduce applications suitable for execution on very many Mapper and Reducer processes, such as millions of Mapper processes and millions of Reducer processes. In this case a benefit of a Partitioning function may be to load balance the Reducers toward being equally likely to be assigned work ([key,value] inputs), and the particular Reducer process that a [key,value] is assigned to may not be important to the functioning of the MapReduce program. Another capability provided by the Partition function is that it allows separate Mapper processes to send [key,value] pairs with the same key to the same Reducer process without those Mapper processes having to communicate with each other. This is assured by having the separate Mapper processes use the same Partitioning function, which deterministically produces a Reducer process assignment, which is the partition, from the key input of a [key,value] input pair.

Subsequent to the above partitioning step, and prior to spilling the data to disk, there is a step which sorts each partition's [key,value] pairs by key. An optional step not depicted in FIG. 1A is the Combining step, which combines values assigned the same key using a user-defined Combiner function. The Combiner function is different from the Reduce function in that a complete list of all values does not need to be provided to the Combiner, thereby allowing it to be performed on the Mapper system after mapping but before data is transmitted to the Reducers that perform the Reduce functions. By performing the Combiner function on the Mapper, the size of data associated with a given key can be reduced since a Combiner function, in the ideal case, converts multiple values into a single value. It is useful to perform this combining step after the Mapper-side sort step since all of the values associated with the same key will have been moved to be adjacent to each other and thus no significant searching is required to perform the Combiner function. Subsequent to the sorting step and the optional Combining step, the sorted partitions are then written to disk as “Mapped Partitioned & Partially Sorted Data” 116. After all of the mapping has completed, the third step 14 in the example depicted in FIG. 1A is performed. In this step a merge sort operation begins wherein data is read from disk (108) which comprises “Partially Sorted Data” 122, and the Mapper #1 (104) performs sorting by merging multiple separate spills of the same partition. If only a single spill was ever performed, then the data is already sorted. However, the example depicted in FIG. 1A assumes that multiple spills have been performed and thus for each partition, data from multiple spills must be merged and sorted together. The merge sort is performed on only a few spills at a time, so that the disk must be accessed for reading and writing multiple times, which the inventors have recognized incurs a significant performance penalty. Once the current iteration of sorting has been performed, but prior to writing the data to disk, a Combiner function may be executed where multiple values map to the same key, similar to the post-sort Combining described above. The results of one of these sorting iterations (with optional combining step) is written back to disk as “Partially Sorted Big Data” 124. Multiple iterations of step 14 may be performed, as indicated by the ellipsis between elements 124 and 130. The second-to-last iteration of merge sorting is marked step 16 which is identical to step 14 except that it operates on merged spill data, merges of merged spill data, or a deeper level of nested merged data, which depends on the number of streams merged per iteration and the number of times data was spilled for each partition.

Upon completion of step 16 of the example depicted in FIG. 1A, Step 18 begins in FIG. 1B. During this step the final merge will be performed for each partition, and instead of writing it back to disk prior to sending each partition to its assigned Reducer, it may be sent directly to the assigned Reducer, thereby saving an extra trip to disk. The Partially Sorted Data (146) is read from Disk (108), processed by the Mapper #1 (104) which performs the final Sorting step of the merge sort and serves the data to the Reducer (134-136) that is to fetch it. Fully Sorted Data Partition 1 (142) is sent by Mapper #1 (104) to Reducer #1 (134). Fully Sorted Data Partition R (144) is data sent by Mapper #1 (104) to Reducer #R (136). To define the nomenclature more rigorously, it can be stated that Reducer #R is the R'th Reducer, and Partition R is the R'th Partition, which is assigned to the R'th Reducer (136). The ellipsis between elements 134 and 136 indicates that Mapper #1 (104) is sending all Fully Sorted Data Partitions to their respective Reducers.

Not only does each Mapper send output to multiple Reducers in the example of FIG. 1B (step 18), but each Reducer receives input from multiple Mappers, which is depicted by diagram 20 in FIG. 1B. Reducer #r, which is the r'th Reducer (not to be confused with the capital letter “R,” since case-sensitive nomenclature is used here) is one of the Reducers and receives input from all of the Mappers in this example. In particular, input is received from Mapper #1 (104) in the form of Mapper #1's Fully Sorted Data Partition r (158), from Mapper #m (152) in the form of Mapper #m's Fully Sorted Data Partition r (160), and from all other Mappers as indicated by the ellipsis between elements 104 and 152. Whereas a single Mapper sends each unique Partition to a unique Reducer, each Reducer such as Reducer #r (148) receives the same partition, i.e., the partition corresponding to itself, from different Mappers. Mapper #1 (104) receives Partially Sorted Data (146) from Disk (108) and outputs Fully Sorted Data (e.g. 158) that is the result of sorting performed internal to the Mapper. Similarly, Mapper #m (152) sorts Partially Sorted Data (164) received from its local disk (156) and outputs Fully Sorted Data (e.g. 160) which is sent to the corresponding Reducer over the computer network.

In step 22 illustrated in FIG. 1C, Reducer #r (148) sends data fetched from Mapper #1 (104) as Fully sorted Data Partition #r part #1 (170) to Disk (168). Reducer #r (148) sends data fetched from Mapper #m (152) as Fully sorted Data Partition #r part #m (176) to Disk (168). This Disk (168) is typically the same hardware Disk for all data bound to or read from Disk by the same Reducer. Once data has been fetched from Mappers and stored to local disk, the Reducer #r 148 performs Reducer-side sorting of the Partially Sorted Data 182 retrieved from Disk 168, which is then saved back to the Disk 168 as Partially Sorted Data 184 in step 24. This sorting process is similar to Mapper-side sorting except that much more data is sorted since all parts must be sorted together. In the typical case where the data does not fit in memory, it is merge sorted using disk space, which the inventors have recognized has the performance penalty as when this is performed on the Mapper side. Combining is not typically performed on the Reducer side by the Reducer. Sorting on the Reducer has the effect of placing [key,value] pairs with matching keys adjacent in memory. Once adjacent in memory, the Reducer operation can proceed in a natural way upon sequential input.

The ellipsis between steps 24 and 26 indicates that many iterations of the merge operation depicted in step 24 may be performed. The second-to-last merge sort operation is performed in step 26 by reading Partially Sorted Data (190) from Disk (168), sorting this data on the Reducer (148) and storing the Partially Sorted Data (192) back to Disk 168. The final sorting operation is performed in step 28 by reading Partially Sorted Data (198) from Disk 168, upon which the Reducer (148) performs sorting. Once the data is completely sorted on the Reducer (or as it is being sorted, since the beginning of the data will be sorted prior to the end of the data when merge sort is used), the Reduce function can be performed by the Reducer. When a new key is encountered, all values assigned to that key can be passed as input (e.g., via an iterator) to a Reduce function execution on the Reducer (148), up until the first value assigned to a different key, which indicates the end of all values for the previous key.

The inventors have recognized that a major performance penalty paid by conventional MapReduce frameworks is caused by disk-based sorting, which can take hours to complete. (Indeed, reading all data that is on a hard drive once can itself take hours.) The inventors have further recognized that conventional disk-based sorting requires all of the data-to-be-sorted to be present on the disk before the sorting task can be accomplished. The inventors have appreciated that this limitation contributes to constraining conventional MapReduce to be performed as a batch process on a complete set of input data, and to making conventional MapReduce unusable for, e.g., streaming data. By contrast, some embodiments disclosed herein can begin executing MapReduce programs on input data as portions of a data set arrive at the file system serviced by the MapReduce system, e.g., before the entire input data set has been received at the file system. Some embodiments may reduce or eliminate disk-based sorting from the MapReduce system, through techniques described further below.

Accordingly, some embodiments described herein relate to techniques which may address one or more of the above-discussed shortcomings of traditional methods, and/or that may provide one or more of the foregoing benefits. However, aspects of the invention are not limited to any of these benefits, and it should be appreciated that some embodiments may not provide any of the above-discussed benefits and/or may not address any of the above-discussed deficiencies that the inventors have recognized in conventional techniques.

In some embodiments, a MapReduce system as described herein may optimistically elect to perform MapReduce programs on incoming input data so that results will be ready when a user or application later requests that such a program be run. When the request to run a given MapReduce program is later received, if it has already been run on the input data, it need not be rerun since the results of the MapReduce program may have already been output and available.

In some embodiments, the MapReduce system may be implemented via one or more MapReduce applications (e.g., software applications) executing on one or more processors, which may cause processing threads on the one or more processors to function as Mappers and/or Reducers in the MapReduce system. In some cases, a computer machine such as a server may have a single processor with a single processor core capable of a single thread of execution. In other cases, a server machine may have multiple processors, and/or a processor may have multiple cores, and/or a processor core may have multiple hardware threads (virtual cores). In some embodiments, a Mapper or Reducer may be executed by a processor thread. Thus, a single-thread, single-core, single-processor server may implement a single Mapper or Reducer at a given time (although it could implement one Mapper or Reducer during one time period and a different Mapper or Reducer during a different time period). A multi-processor and/or multi-core-per-processor and/or multi-thread-per-core server could potentially implement up to as many Mappers and/or Reducers as it has hardware threads in parallel at the same time.

In some embodiments, the MapReduce application(s) executing on one or more processors may monitor a file system to detect when data is written to the file system by one or more other applications (i.e., applications other than the MapReduce application(s)). The file system may be implemented on one or more nonvolatile storage media, such as a hard drive, a storage array, or any other suitable nonvolatile storage media. In some embodiments, the file system may represent a virtualized construct of logical volumes presenting an organization of the data that differs from how the data is physically stored in the hardware storage media. As such, in some embodiments, the MapReduce application(s) may monitor writes to the file system (e.g., to the abstraction layer) as opposed to the hardware storage media themselves. In other embodiments, the file system monitored by the MapReduce application(s) may simply be the nonvolatile storage media in which the data are stored.

In some embodiments, in response to input data being written to the file system by another application, one or more Mappers in the MapReduce system may access and execute one or more known Map functions on the input data. In this way, [key, value] pairs resulting from execution of the known Map function(s) can be precomputed so that they will be immediately available in the case of a later user or application request for the MapReduce program(s) including those Map function(s) to be performed on the input data. In some embodiments, the [key, value] pairs output by the Mapper(s) may be stored in one or more nonvolatile storage media, such as the media underlying the file system to which the input data is stored, one or more disks local to the Mapper(s), and/or any other suitable nonvolatile storage media. Alternatively or additionally, in some embodiments the output [key, value] pairs may be transferred to one or more Reducers in the MapReduce system for execution of the Reduce function and precomputation of the output of the MapReduce program. In some embodiments, a Map function or a MapReduce program (including both Map function and Reduce function) may be executed on input data as it arrives at the file system, e.g., as in the case of streaming data. In some embodiments, execution of a Map function on a portion of the input data stream may commence before other portions of the input data stream have been written to the file system by the other application. In some embodiments, furthermore, multiple Map functions or multiple MapReduce programs may be precomputed on input data upon its arrival at the file system, as described further below. In some embodiments, when a MapReduce program has been precomputed on input data but no request is later received for the MapReduce program to be executed (or its results to be output), the precomputed results may be discarded. For example, in some embodiments, precomputed MapReduce program results may be discarded after a suitable threshold time period has elapsed, or after a suitable threshold amount of precomputed data has been accumulated, or according to any other suitable criteria in the absence of receiving a request for the precomputed data. Discarding precomputed data may include deleting the data, transferring the data to a different location or file system, or otherwise disposing of the data in the context of non-use.

It should be appreciated that the foregoing description is by way of example only, and aspects of the invention are not limited to providing any or all of the above-described functionality, although some embodiments may provide some or all of the functionality described herein.

The aspects of the present invention described herein can be implemented in any of numerous ways, and are not limited to any particular implementation techniques. Thus, while examples of specific implementation techniques are described below, it should be appreciated that the examples are provided merely for purposes of illustration, and that other implementations are possible.

FIG. 2 is a high-level diagram of a system in accordance with some embodiments. Here, a Mapper (200) receives Input Data (215) from a Data Source (210). Instead of being propagated to Disk (230) alone, it is also propagated to an Accelerator (220) associated with the Mapper (200). Accelerator 220 may be implemented in any suitable way, including as hardware, software, or a combination of hardware and software. In some embodiments, the Accelerator (220) is built into the Mapper (200) such as a Peripheral Component Interconnect (PCI) Express accelerator card embodiment. In some embodiments, a module built into the Mapper (200) that splits Input Data (215) to both Disk (230) and Accelerator (220) may be implemented in the disk driver such that neither the Data Source (210) sending the Input Data (215) to the Mapper, nor any downstream processing systems that will use the Input Data (215) stored to Disk (230) needs to be updated to allow the Accelerator (220) to process Input Data (215).

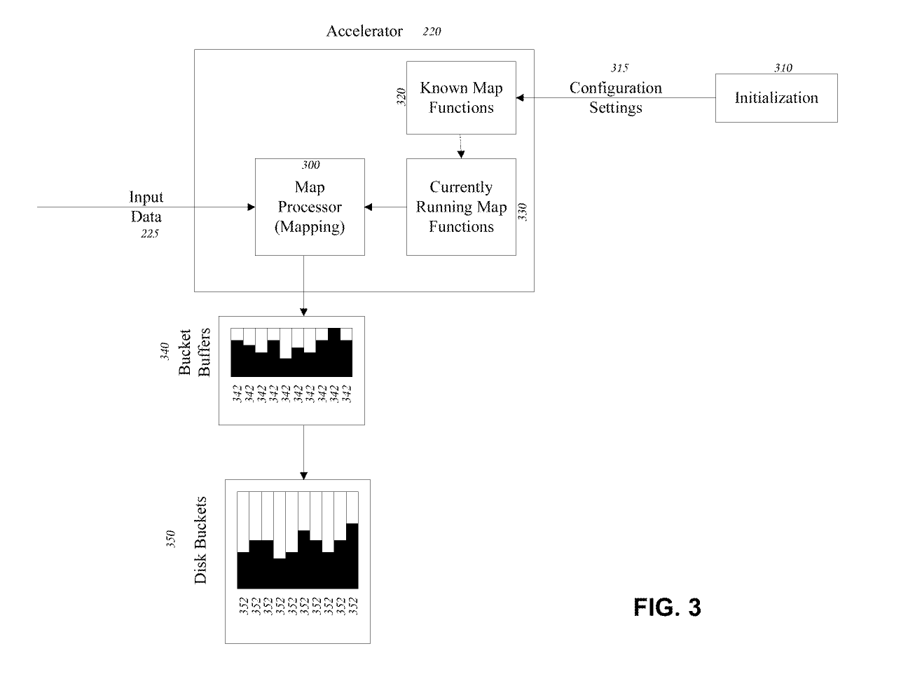

FIG. 3 depicts exemplary system components suitable for implementing a Map-on-Write feature, in some embodiments, as well as for elimination of sorting in a MapReduce process. Each component in this example may be implemented in any suitable way, including as hardware, software, or a combination of software and hardware. In some embodiments the Accelerator (220) comprises a PCI Express card including flash memory implementing the Disk Buckets (350). In some embodiments, Dynamic Random-Access Memory (DRAM) modules integrated through a Dual In-line Memory Module (DIMM) socket may provide the Bucket Buffers (350) with memory space, In some embodiments, an Application-Specific Integrated Circuit (ASIC) or Field-Programmable Gate Array (FPGA) may be used to implement the Map Processor (300). In some embodiments the Input Data 225 arrives over a PCI Express connection such as, e.g., four lanes of PCI Express 2.0. In some embodiments the Initialization (310) is commanded by software executing on a host processor also connected to the PCI Express network to which the Accelerator (220) may be connected. In some embodiments motherboard DRAM may store Configuration Settings (315) and they may be transmitted to the Accelerator (220) over the PCI Express network. In some embodiments the Map Processor (300) is implemented in FPGA using soft processor cores and the Known Map Functions (320) are stored in a configuration memory such as flash memory which may subsequently be used to configure the FPGA Map Processor when loaded as the Currently Running Map Functions (330). The inventors have appreciated that modern FPGA allow partial reconfiguration of FPGA so that Map Functions may be loaded and unloaded separately from each other. In some embodiments the Map Processor is a multicore processor with each processor core itself implementing multiple hardware threads with fine grain context switching to allow for latency network and Disk IO latency tolerance. In some embodiments the Disk Buckets (350) are implemented with multiple small disk drives, such as four laptop drives (e.g. 2.5-inch form factor), and the Map Processor and Disk Buckets are integrated into a chassis the size of a larger server disk drive (e.g. 3.5-inch form factor). In some embodiments effective cooling of the Map Processor and Disks may be achieved by a power-efficient implementation of the Map Processor such as by implementing the Map Processor as an ASIC with many slower processor cores that provide high throughput in aggregate while consuming low power. In some embodiments this may provide a drive module the size of a normal server hard drive with, e.g., four times as much sequential-read/write bandwidth and four times as many random seeks per second due to having four times as many hard drives in the form of smaller laptop hard drives. In some embodiments the Map Processor (300) accesses the Disk Buckets (350) directly via Serializer/Deserializer (SERDES) connections that support SATA communication to the drives. In some embodiments the disks are treated as JBOD (“Just a bunch of disks”), which is a paradigm that uses software to control parallel accesses to increase performance in contrast to high performance Redundant Array of Independent Disks (RAID) implementations that hide the details of the multiple disks with a RAID abstraction layer. In some embodiments, the ability for Map Functions to execute in parallel on parallel processing cores and/or parallel processing threads on the Map Processor (300) may enable access to a JBOD implementation of the Disk Buckets (350) to deliver high performance without the power consumption or additional hardware resources that would be involved in providing the traditional RAID abstraction.

In some embodiments, an Initialization unit (310) may transmit Configuration Settings (315) to the Accelerator (220) during an initialization phase. In some embodiments, the Configuration Settings (315) may configure a storage of Known Map Functions (320). Once the Known Map Functions (320) have been initialized within the Accelerator (220), a selection of them, which may comprise all of them, may be loaded into the Currently Running Map Functions (330) unit. Alternatively a load-balanced selection of MapReduce algorithms may be selected such that output bandwidth to disk and computational requirements may be used in a balanced way. For example, the selection may be made such that the output bandwidth to disk is exhausted while computational resources are unused, only to later run a different selection of MapReduce programs where the opposite resource utilization would be observed. In some embodiments, one or more of the Known Map Functions (320) may be selected based on their being applicable to the Input Data (225). For example, in some embodiments, a set of one or more Map functions may be selected based on the Map function(s) being applicable to input data of a certain form, such as text data, numerical data, data from a particular domain or data source, etc. In some embodiments, a subset of the Known Map Functions (320) may be selected based on their being capable of execution on streaming input data.

As Input Data (225) arrives as input to the Accelerator, it arrives at a Map Processor (300) (or processors). The Map Processor (300) loads a Map function from the set of Currently Running Map Functions (330). The Map Processor (300) then performs Input Splitting, Input Reading, and Mapping according to the specification of the loaded Map function. In some embodiments, the Map Processor (300) may implement a Java Virtual Machine (JVM) and the Map functions may be specified in Java and utilize a MapReduce library and JVM optimized for execution on the Accelerator's Map Processor(s) (300). Upon loading a piece of Input Data (225), loading of the next piece of Input Data (225) may continue while the current piece of Input Data (225) is being processed. During this process each Currently Running Map Function (330) may be loaded in turn and operated upon the current piece of Input Data (225). Once one Map Function completes on the current piece, the next Map Function may be loaded from element 330. If data arrives faster than it can be processed, the set of Currently Running Map Functions may be adjusted so that the Map Processor and output bandwidth (see Disk, 350) can keep up.

In some embodiments, the Map Processor may perform a segmentation operation on output [key,value] pairs that differs from the conventional Partitioning operation (FIG. 1) at least in that [key,value] pairs, in some embodiments, may be assigned to the same segment but be bound for distinct Reducers. In some embodiments, a storage system in which a Mapper's output [key, value] pairs are written may be organized into multiple divisions, with different divisions storing [key, value] pairs corresponding to different keys, and with one or more individual divisions storing [key, value] pairs corresponding to keys assigned to be handled by different Reducers. That is, in contrast with conventional Partitioning functions that assign only one Reducer's keys to the same partition, in some embodiments a Mapper's output [key,value] pairs may be written to divisions of a storage system with multiple Reducers' keys being assigned to the same division. In some embodiments, the assignment of keys to divisions may be performed in such a way as to maximize the number of Reducers represented in the same division (i.e., to maximize the number of Reducers handling keys corresponding to [key, value] pairs stored together in the same division). For example, in a case in which each Reducer handles multiple keys, the [key, value] pairs corresponding to the keys handled by a particular Reducer could be distributed across the divisions of the storage system, such that each key is assigned to one division, but each division receives keys for as many Reducers as possible.

In some embodiments, there may be two different storage systems that may receive mapped [key, value] pairs—one implemented on one or more volatile storage media (e.g., a Mapper's internal or local memory, which in some embodiments may be dynamic random-access memory (DRAM), or other suitable volatile storage media), and one implemented on one or more nonvolatile storage media (e.g., a Mapper's hard disk, or other suitable nonvolatile storage media). In some embodiments, [key, value] pairs may first be collected in a set of buffers in the volatile storage system, and appropriately moved to a set of divisions (referred to herein as “buckets”) in the nonvolatile storage system as necessary or desired.

In some embodiments, each key may be assigned a segment which corresponds to a particular Bucket Buffer (342) in the set of Bucket Buffers (340) of the volatile storage system, in which [key, value] pairs corresponding to that key may be stored prior to arriving in the corresponding Disk Bucket (352) in the set of Disk Buckets (350) of the nonvolatile storage system. In some embodiments, the Disk Buckets (350) may lie on disk, which may not be capable of writing individual [key,value] data at distinct locations without some performance penalty, as the inventors have recognized. This is because disk storage today is primarily a sequential medium with random access time measured in milliseconds and only a hundred or so of these can be performed per second per disk. Contrast this with Random Access Memory (RAM), which measures random access time in nanoseconds, millions of which can be performed per second. The opposite of random access is sequential access. The inventors have appreciated that one way to achieve high disk IO bandwidth while still performing random accesses may be to make each random access perform a data operation that is of a sufficiently large size, for example, to balance the amount of time the storage medium spends seeking with the amount of time the storage medium spends writing. For a disk drive this might be, for example 4 Megabytes (“4 MB”). For example, considering a disk having sequential read/write speeds of around 400 MB/sec and seek times around 6-10 ms, allowing for around 100 random seeks per second, balancing the write time against the seek time may result in a desired write size of 400/100=4 MB written per seek. Thus, in some embodiments, the performance of the disk IO bandwidth relative to peak bandwidth (i.e., completely sequential) can be controlled by establishing an efficient write size, e.g., determined by Bucket Buffer size. At 4 MB it is not unreasonable to assume that a disk drive could support 100 writes (or reads) of 4 MB to random locations on disk per second. The bucket buffers, in some embodiments, may allow data destined for a particular Disk Bucket (352) to be pooled until it is of sufficiently large size to allow an efficient disk access (i.e., at a desired ratio of seek time to total (seek+write) time). In one embodiment, each Bucket Buffer (342) is 4 MB and the fullest Bucket Buffer (342) is constantly being emptied to Disk Bucket (352) to avoid the buckets becoming too full (i.e., running out of space in the Bucket Buffer 342, which could call for some software handling to deal with, which the inventors have recognized could lower performance in some cases). For example, in some embodiments, emptying of the next fullest buffer may begin in response to completion of the emptying of the previously fullest buffer.

Given a desirable disk access chunk size (e.g. 4 MB), the number of buckets to support may be determined, in some embodiments, using a calculation technique. In this particular exemplary technique, first, the size of the storage space on the Disk that is the maximum that will be utilized by the MapReduce system may be determined. As an example, a 4 Terabyte (“4 TB”) disk drive may be fully dedicated to holding data for MapReduce, and the system may support up to its full utilization. In this case the working memory of the Map Processor (300), which may be the memory supporting the Bucket Buffers (340) or it may be memory internal to the Map Processor (300) or some other memory, may be established to be sufficiently large to hold an entire Disk Bucket (352) so that the keys in the Disk Bucket might be organized using the working memory (when it is not being otherwise used to store [key, value] pairs in Bucket Buffers 340), such as by creating a hash table of the key values. For example, in some embodiments, after processing of a Map function has completed on Input Data 225, and mapped [key, value] pairs have been assigned to and stored in Disk Buckets 350, the [key, value] pairs stored together in a Disk Bucket (352) may be read into memory, separated by their keys (e.g., using a hash table) into data bound for different Reducers, and then transferred to the appropriate Reducers for processing according to the Reduce function. The memory in which data from completed Disk Buckets is prepared for routing to Reducers may be the same memory in which Bucket Buffers 340 were previously implemented during processing of the Map function, or may be a different memory. In a some embodiments, this working memory is planned to be twice the size of a Disk Bucket (352) to allow for a hash table to be efficiently implemented with empty room, which may allow the hash table to operate efficiently.

In some embodiments in which the Bucket Buffers are implemented in the working memory of the Map Processor (300), desired sizes for separate Bucket Buffer (340) and working memory may be determined using any suitable calculation process, one non-limiting example of which is described below.

An exemplary calculation to determine the number of buckets to be supported may be performed iteratively by starting with a working memory that is too small or at least can be trivially supported in hardware. One can start an example of this process at 512 Megabytes (“512 MB”). Because one knows the desired size of each Bucket Buffer (342) is 4 MB (see above) one can divide the total Bucket Buffers (340) memory size (512 MB) by this (4 MB) to arrive at a number of buckets supported. In this case that is 512/4, which is 128 buckets. Suppose that each Disk Bucket (352) was written to disk many times during a set of MapReduce processes that have approximately filled each bucket on disk. In this case (in which each Bucket Buffer in memory has a corresponding Disk Bucket on disk) the 4 TB have been written to disk in 128 separate buckets. The size of each bucket on disk is 4 TB/128, which is 32 GB. The data in each bucket is unsorted and thus if the working memory of the Map Processor (300) is less than 32 GB then the data may be difficult to organize efficiently. The exemplary calculation continues by increasing the size of the working memory and Bucket Buffers (340) to 1 GB.

The above process is then performed again starting with a total memory size of 1 GB, and the size of the working memory and Bucket Buffers (340) is increased until it is of sufficient size to establish a Disk Bucket size that does not exceed the size capacity of the working memory. 1 GB/4 MB=256, therefore a 1 GB Bucket Buffers (340) and working memory would allow for 256 separate buckets (342, 352). If each of these buckets (352) has been nearly filled on Disk (350) then each bucket holds approximately 4 TB/256=16 GB. Since 16 GB may not be efficiently organized with Bucket Buffers (340) and working memory of size 1 GB, the size of the memory may be increased again.

At 2 GB the Bucket Buffers (340) and working memory supports 2 GB/4 MB buckets, which is 512 buckets. When Disk (350) is full, these buckets (352) will be 4 TB/512 in size, which is 8 GB. 8 GB is larger than the 2 GB memory and thus the size of the Bucket Buffers (340) and working memory may be increased again, this time to 4 GB. Now the Bucket Buffers (340) can support 4 GB/4 MB, which is 1024 buckets. When disk is full each Disk Bucket (352) will be about 4 TB/1024, which is 4 Gigabytes in size. Since the working memory is 4 GB, a full bucket can be read from disk and organized in memory. Thus 4 GB may be approximately the right size for the Bucket Buffers and working memory in this example. In some embodiments, once the appropriate size for the Bucket Buffers (340) has been determined, the hardware may be designed with such a memory. Thus this calculation may be performed at design time, in some embodiments. It is also possible to use the above calculation technique to determine what capacity of disk is supported by a given size of Bucket Buffers (340) and working memory (given, e.g., the desired disk access data chunk size, e.g., 4 MB). In other embodiments, however, it may not be possible or desirable optimize the size of a Mapper's volatile or nonvolatile storage system at design time, and calculations may instead be performed later, given predetermined hardware capacities, to determine appropriate numbers and/or sizes of divisions (e.g., buckets, buffers) to implement in the storage system(s). In other embodiments, appropriate numbers and/or sizes of storage system divisions may be determined based on any suitable considerations other than hardware capacities, such as characteristics of a Map function and/or of input data, such as the number of keys to be supported, etc. Also, although examples described above have incorporated equal-sized storage system divisions and corresponding numbers of memory buffers and disk buckets, it should be appreciated that such designs are not required, and in other embodiments divisions may be established of unequal sizes and/or numbers.

According to any suitable Bucket Buffer emptying policy, such as the “fullest bucket first” priority scheme described previously, data in a bucket buffer (342) may be added to its corresponding Disk bucket (352) in some embodiments.

In some embodiments, a set of Map Processors (300) may be associated with a working memory of size 4 GB and Disk buckets (350) of capacity 4 TB. In some embodiments, the disks may be physically implemented as four separate 1 TB 2.5″ drives, which may allow higher aggregate bandwidth and a higher number of disk seeks per second than a single 4 TB drive. In some embodiments, the Accelerator may use the Mapper's motherboard DRAM memory in a size of 4 GB and interact directly over PCI express with this memory as well as with the disks via a Redundant Array of Independent Disks (RAID) controller also connected via PCI Express, which the Map Processor may have driver software to control.

In another embodiment, the RAID controller and Accelerator 220 may be connected to a PCI express switch that is separate from the Mapper's PCI express switch, so that the Disks (350), Accelerator (220), and RAID controller can all be integrated into the same chassis module. This may allow these components to be added to a Mapper as a single unit. In some embodiments, multiple such units may be added to a single Mapper depending on cost, workload, and desired performance. The PCI Express switch built into the Accelerator's housing could then provide a single uplink to the motherboard PCI Express Switch, enabling the unit to use a single interface to the motherboard.

In some embodiments, although a Disk may support 4 TB, it may be chosen slightly oversized and typical use may tend to fill each bucket half-full, or 2 GB each in the example above. In this case, the 4 GB of memory could be used to provide space for an efficient hash table for organizing an entire 2 GB worth of bucket data (352) (i.e., empty space may be available so that collisions may be sufficiently infrequent as to be efficient).

In another embodiment, the Map Processor (300) may interact directly with a Dual In-line Memory Module (DIMM) holding 4 GB of data. In another embodiment, a Field-Programmable Gate Array (FPGA) may connect to the same PCI Express switch as the Accelerator (220) and also to several DRAM modules that together comprise 4 GB. The FPGA may be configured to allow the Accelerator (220) to efficiently interact with the DRAM memory modules in the case that the Accelerator (220) does not have a direct interface for DRAM memory modules. Thus, in some embodiments, an Accelerator (220) that contains only a PCI Express switch interface may be integrated into the system using PCI-express-attached memory and PCI-express-attached disk, and this may all be integrated into a combined housing that exposes a single physical PCI Express interface that may be connected to the Mapper motherboard.

In some embodiments, the determination of which Bucket Buffer (342) a particular [key,value] pair is moved to by the Map Processor (300) may be performed by a deterministic hashing function that gives each Bucket Buffer (342) an equal chance of having a [key,value] pair added to it. Any suitable hashing functions may be used for this purpose; one non-limiting example is SHA-1 (“secure hash algorithm 1,” published by the National Institute of Standards and Technology) combined with a mod (remainder) function. For example, a key might hold the value 8512, which might be hashed to 7070, and then further hashed with a mod function so that it is within the bounds of the number of buffers. Thus 7070 would be modded by 1024 in the case that 1024 buckets are available, resulting in a value of 926. Thus the [key,value] would be placed in bucket 926. Some embodiments may add to a [key,value] pair a third attribute in the case that [key,value] pairs from different MapReduce algorithms share data structures such as Bucket Buffers (340) and Disk Buckets (350). An attribute indicating which MapReduce program the [key,value] has been produced by (and will be consumed by) may be added to the pair [key,value]. Logically this may be considered as transforming each [key,value] pair into a [key,value,program] triplet. The program attribute may determine which program will be loaded to process the [key,value] pair held by the triplet. In some embodiments the data structures that manage the organizing and routing of the keys may use an alternative key based on the original key but with the program attribute (or a hash of it) prepended (thus the new key may be a product of the original key and the program attribute, in some embodiments).

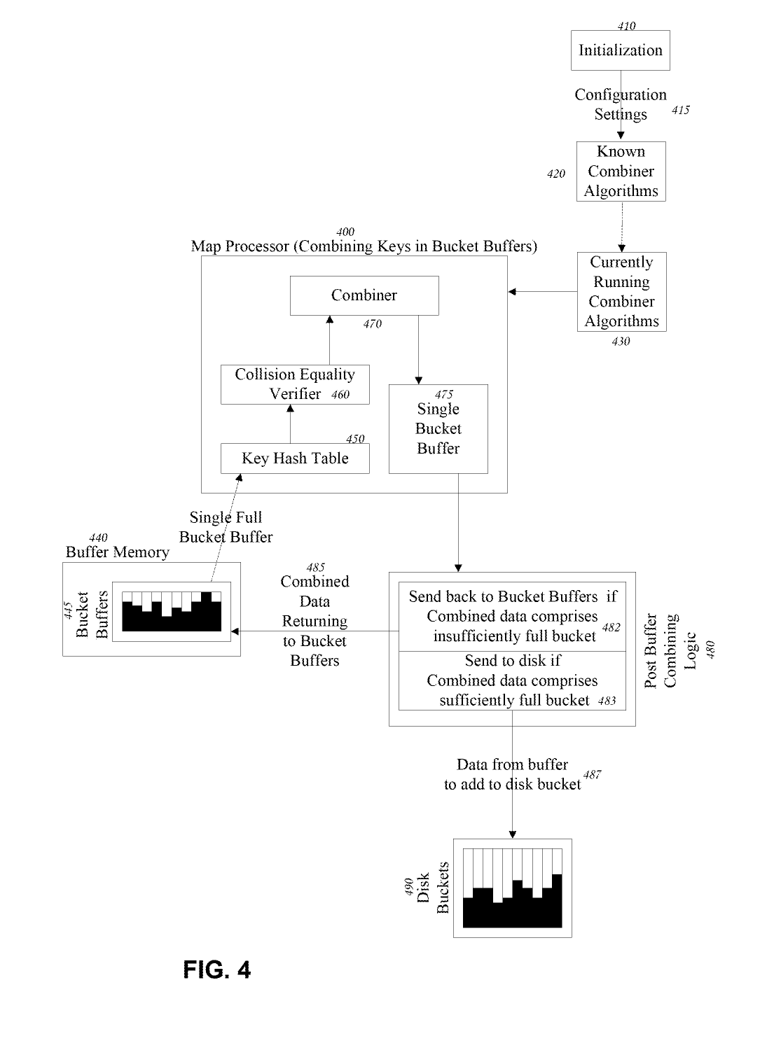

FIG. 4 depicts an aspect of some embodiments that may be configured to avoid the type of sorting that would require [key, value] pairs to be written to and read from disk multiple times back and forth during the sort, and/or to avoid the type of sorting that would typically involve accessing [key, value] pairs that are stored together in memory and comparing them to each other to decide whether they need to be reordered, such as conventional techniques that involve a merge sort. FIG. 4 depicts in greater detail how data held in Buffer Memory 440 (analogous to element 340 of FIG. 3) may be propagated to Disk (490) in an efficient way.

The arrows in FIG. 4 depict data and decision flow as it passes from unit to unit in order to carry out movement of data held within Bucket Buffers (445) back to Bucket Buffers (445) after a Combiner operation (if any Combiner operation is defined for a particular MapReduce program), or to Disk Buckets (490) after a Combiner operation, if any such operation is defined. Each exemplary unit depicted in FIG. 4 may be implemented in any suitable way, including as hardware, software, or a combination of hardware and software. The example depicted in FIG. 4 includes an Initialization unit (410) sending “Configuration Settings (415) to a Known Combiner Algorithms unit (420) comprising data storage. The set of Currently Running Combiner Algorithms (430) is configured by the Known Combiner Algorithms unit (420), and the Currently Running Combiner Algorithms (430) are made available to the Map Processor (400). The Initialization (410), Configuration Settings (415), Known Combiner Algorithms (420), and Currently Running Combiner Algorithms (430) are analogous to the Initialization (310), Configuration Settings (315), Known Map Algorithms (320), and Currently Running Map Algorithms (330) of FIG. 3, but the components in FIG. 4 pertain to the Combiner functions of the loaded MapReduce programs as opposed to the Map functions (which were performed prior to the data being originally moved to the Bucket Buffers (340, 445).

In the example depicted in FIG. 4, data from a full Bucket Buffer (depicted as the fully black column of the Bucket Buffers (445) that is second from the right) is read by Map Processor 400. Alternatively a nearly full or merely the most full bucket may be selected, or some other selection criteria may be used. In some embodiments, which may support real-time monitoring of the MapReduce process, when no Bucket Buffer (342) is more than half-full, then the least-recently emptied buffer may be selected. The inventors have appreciated that this technique may decrease the likelihood that data will be held in Bucket Buffers indefinitely, which might raise red flags if the flow of this data is being monitored in real time to verify proper operation (frameworks such as Twitter Storm have such monitoring built in, and such monitoring is in the process of being integrated into MapReduce frameworks).

In the example of FIG. 4, the Selected Bucket Buffer is sent to the Key Hash Table (450), which may be of sufficient size to hold all of the keys that can fit in a Bucket Buffer. In some embodiments this Key Hash Table may be implemented with on-chip memory designed into the Map Processor at a capacity that is sufficient to hold Bucket Buffers. For example if Bucket Buffers (342) grow as large as 4 MB, then the Key Hash Table may be designed to be 8 MB or 12 MB to allow empty space in the hash table when 4 MB of it is filled with Bucket Buffer (342) data. In some embodiments, the Key Hash Table may be configured such that [key,value] pairs that have the same key (and program attribute, if any) will collide in the Key Hash Table. Such collisions are transmitted to the Collision Equality Verifier (460) in the example of FIG. 4. If multiple [key,value] pairs are found to have the same key and MapReduce program, then their values may be processed by a Combiner (470) in the case that such a Combiner (which is optional) exists for the given MapReduce program that is operating that [key,value]. If such a Combiner exists then it may be loaded into the Combiner (470) and data that is to be combined may be sent from the Collision Equality Verifier (460) to the Combiner (470). The value(s) output from the Combiner (470) may replace the original values in the Key Hash Table. If no Combiner is defined for a given MapReduce program, then in some embodiments, the corresponding [key, value] pairs may be left unchanged by Combiner 470; although in some embodiments, [key, value] pairs found to have the same key may be moved adjacent to each other in storage if not Combined. In some embodiments, when adjacent [key, value] pairs have the same key, storage space may be conserved by storing a single copy of the key in association with both values. Once all collisions have been verified to not have equality, or to have been combined, the final [key,values] are depicted in the example of FIG. 4 as being held in unit 475, although in some embodiments this may be a logical unit not directly written by the Combiner, but instead held within the Key Hash Table. Since the Key Hash Table in some embodiments may physically have significant empty space (e.g., so as to maintain efficient implementation of the Hash Table), the Single Bucket Buffer logically represents the data held in the Key Hash Table without this empty space, after all possible Combiner operations have been performed.

In the example of FIG. 4, a decision is made by the Post Buffer Combining Logic (480) which uses the Single Bucket Buffer (475) as input. Since a potential goal of the operation depicted in FIG. 4 may be to make room in the Bucket Buffers (445) for new values, it may be sufficient to compress the data held within them by using the Combiner (470) rather than fully emptying them to Disk 490. If Combiner functions performed a high degree of compression then they may not need to be written to disk (since the data may be small enough to fit in the original Bucket Buffer (342) with plenty of room to spare for new values), and this option is depicted as element 482 sending “Combined Data Returning to Bucket Buffers” (485) back to the Bucket Buffers (445). The “Send to disk if Combined data comprises sufficiently full bucket” unit 483 may alternatively direct the data not to Bucket Buffers (445) but to Disk Buckets (490) to which they may be appended. Adding bucket buffer data (487) to a disk bucket may be carried out in some embodiments by appending the bucket buffer data to a file that represents the corresponding disk bucket, with each disk bucket having its own file on the disk.

The Bucket Buffers (445) are depicted in the example of FIG. 4 as held within the Buffer Memory 440 to illustrate that the Buffer Memory (440) may also be used in some embodiments for purposes besides Bucket Buffers (445), such as for the purpose of buffering other kinds of data when Bucket Buffers (445) are not needed (which may be the case when all buffers have been emptied and no additional input data is anticipated).

In some embodiments, Buffer Memory 440 may be implemented with one or more DRAM chips, e.g., integrated in a DIMM. In some embodiments, Map Processor 400 may be a processor including a set of cores connected by a network-on-chip. Each core may implement multiple hardware threads, in some embodiments, which may utilize fine-grain context switching to allow for high latency tolerance for network operations. In some embodiments, the Map Processor may include an FPGA. In some embodiments, the Map Processor may include an Application-Specific Integrated Circuit (ASIC). In some embodiments, a cacheless memory system may be integrated on the Map Processor, while in other embodiments, an incoherent cache may be implemented, which may provide better performance at a lower level of power consumption. In some embodiments, Key Hash Table 450 may be implemented using in-package memory coupled with the Map Processor; in other embodiments, Key Hash Table 450 may be implemented with on-chip Static Random-Access Memory (SRAM). The inventors have appreciated that SRAM may be more suitable if the size of a full Bucket Buffer is similar to the amount of on-chip SRAM that can be integrated on the Map Processor. In some embodiments, Known Combiner Algorithms 420 and/or Currently Running Combiner Algorithms 430 may be held in on-chip memory, such as SRAM, embedded DRAM, or on-chip Flash memory. In some embodiments, Single Bucket Buffer 475 may be held in on-chip embedded DRAM, SRAM, or a combination of both. In some embodiments, Post Buffer Combining Logic 480 may be implemented in software. In some embodiments, Disk Buckets 490 may be implemented with a RAID disk array, a single disk, and/or one or more Flash memory devices.

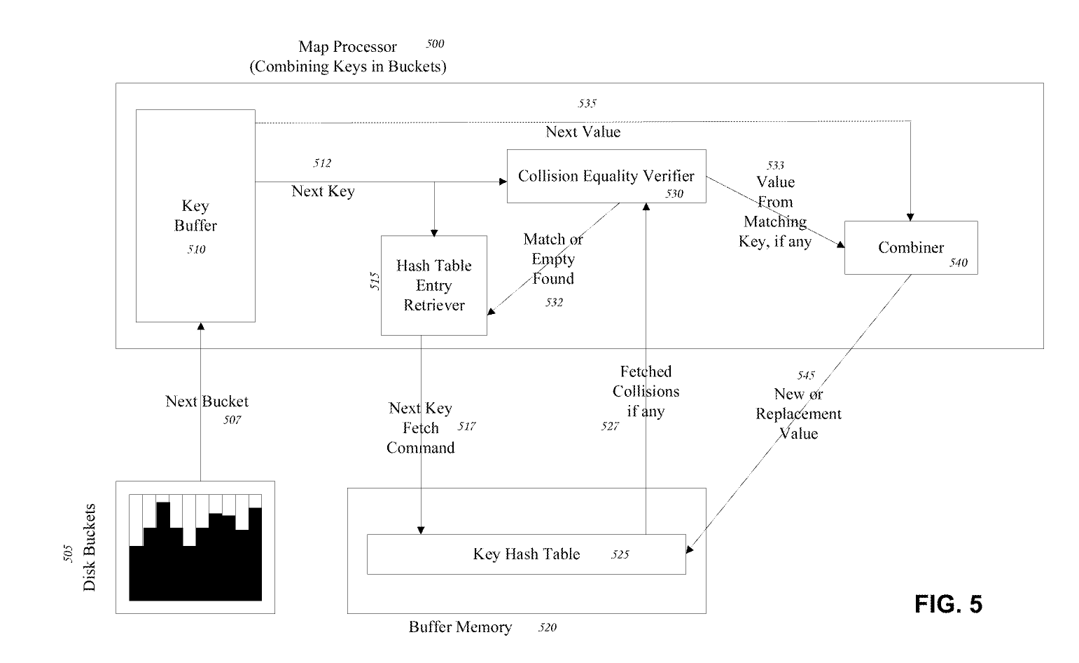

FIG. 5 depicts an exemplary Combining process that may be implemented in some embodiments as Map results are read out of Disk Buckets (505), in such a way as to allow Disk Bucket data to be read from the disk once, combined if appropriate, and transferred to the appropriate Reducers without requiring further writes back to the disk before the transfer. Since the disk read may be one-time, some embodiments may achieve a performance advantage over conventional iterative Mapper-side disk-based merge sort designs.

Each exemplary component depicted in FIG. 5 may be implemented in any suitable way, including as hardware, software, or a combination of hardware and software. In some embodiments, Key Buffer 510 may be implemented using registers or memory onboard the Map Processor. In some embodiments, Hash Table Entry Receiver 515 may be implemented via a register loaded by a Load/Store unit integrated into the Map Processor, with a software instruction executed by the Map Processor directing the Load/Store unit as to which piece of the Key Hash Table 525 should be fetched. In some embodiments, Collision Equality Verifier 530 may be implemented via software that, for example, first checks a hash of keys for equality and second checks on a byte-by-byte basis for an exact match of all components of the key. In some embodiments, the Combiner may be implemented via software, e.g., executing within a Java virtual machine executing on the Map Processor.

In some embodiments, buckets may be loaded in a deterministic order such that each Mapper selects the Next Bucket (507) to load in the same order. The inventors have appreciated that this may enable Reducers to process all of the values assigned to the same key whenever the Reducer has loaded its portion of the X'th bucket from each of the Mappers. For example, a Reducer may perform Reduce operations on all of the [key,value] pairs sent to it after all of the Mappers have sent out their first Disk Bucket to the Reducers. Similarly, a Reducer may perform Reduce operations on all of the [key,value] pairs sent to it after all of the Mappers have sent out their second Disk Bucket to the Reducers, and so on. The inventors have appreciated that this technique may allow the Reducers in some embodiments to process data before all of the data has arrived. By processing data as it arrives the Reducers may not require disk-based storage, thereby reducing the cost of the Reducers. The Reducers may furthermore be implementable at a finer granularity of computational elements (e.g., using 100-core processors that have no disk, rather than 10-core processors that have 10 disks, which may have performance and cost advantages).

In the example illustrated in FIG. 5, the Key Buffer (510) receives the Next Bucket (507), from which keys and values may be processed individually. In some embodiments, functional logic implementing the Next Bucket (507) and Key Buffer (510) may be implemented via a small memory insufficient to hold an entire bucket. In some embodiments the data delivered through the Next Bucket (507) link to the Key Buffer (510) is the next key and value that are to be stored in the Key Buffer so that such data is ready to be transmitted via Next Value (535) and Next Key (512) paths when needed by the downstream units (515, 530, 540). The Key Buffer (510) may be implemented as hardware, software, or a hybrid including hardware and software, with Next Keys (512) and Next Values (535) sent as they are received from Disk (505). The next [key,value] pair from the Next Bucket (507) may be sent from the Key Buffer (510) as outputs 512 and 535. In the example of FIG. 5, the Next Key (512) propagates as input to the Collision Equality Verifier (530) and to the Hash Table Entry Retriever (515). In some embodiments, the Hash Table Entry Retriever (515) may not know the precise location where the input key (512) is located in the Key Hash Table (525), or whether it is in the Key Hash Table (525) at all, however it may know where to start looking in the Key Hash Table based on the key value, and it also may know where to look next in the event that a non-matching collision is detected. If Match or Empty Found (532) is True, then the search for a match in the Key Hash Table (525) can stop since these are both conclusive findings. Once the search stops the location in the Key Hash Table where the Next Key (512) is to be stored has been found. In the case that an empty slot has been found prior to any match, the empty slot may be the location where the key is to be stored. In the case that a match has been found, the key may be stored in this same place, and only a value may be changed or added to the value or list of values associated with the key.

In the example of FIG. 5, the location of the next slot to search in the Key Hash Table (525) is sent from the Hash Table Entry Retriever (515) as Next Key Fetch Command 517. If the slot is empty this is transmitted to the Collision Equality Verifier (530) as Fetched Collisions (527) for subsequent communication to the Hash Table Entry Retriever (515). If the slot is occupied, the key in that slot may be sent to the Collision Equality Verifier (530) as Fetched Collisions (527). In the event that a key is input to the Collision Equality Verifier (530) from Key Hash Table (525), it is compared with the Next Key (512) input, and a signal indicating whether the keys match is sent to the Hash Table Entry Retriever (515). Similarly, if no key is received by the Collision Equality Verifier (530) from the Key Hash Table (525), then this is indicated to the Hash Table Entry Retriever (515).

If a match has been found by unit 530 then the value held with that key in the Key Hash Table (525) is transmitted to the Combiner (540) (if the MapReduce program for that [key,value] has a Combiner associated with it) as the Value From Matching Key (533), in the example of FIG. 5. The Combiner is loaded with the relevant Combiner function as determined by the MapReduce program associated with the [key,value] pair, and the Combiner operates on the Next Value (535) together with the Value From Matching Key (533). The resulting value(s) are sent by the Combiner (540) to the Key Hash Table (525) as New or Replacement Value (545). In the typical case that one value is output by the Combiner (540) and one value was previously associated with the key in the Key Hash Table (525), then the old value may simply be replaced with the new value for the key. The location for the replacement may be indicated by the Hash Table Entry Retriever (515) via element 517.

Key matching in this example, as well as in the example of element 460 in FIG. 4, indicates that both the key and the MapReduce program match. If the keys match but the MapReduce program attributes do not match, then in some embodiments the verifiers may determine that the keys do not match.

The Key Hash Table (525) is depicted in FIG. 5 as a component of the Buffer Memory (520). In some embodiments, this may be the same physical memory as that depicted as element 440 in FIG. 4, signifying that the Buffer Memory can be repurposed once Bucket Buffers (445) are no longer needed and the subsequent need for memory space for the Key Hash Table (525) occurs.

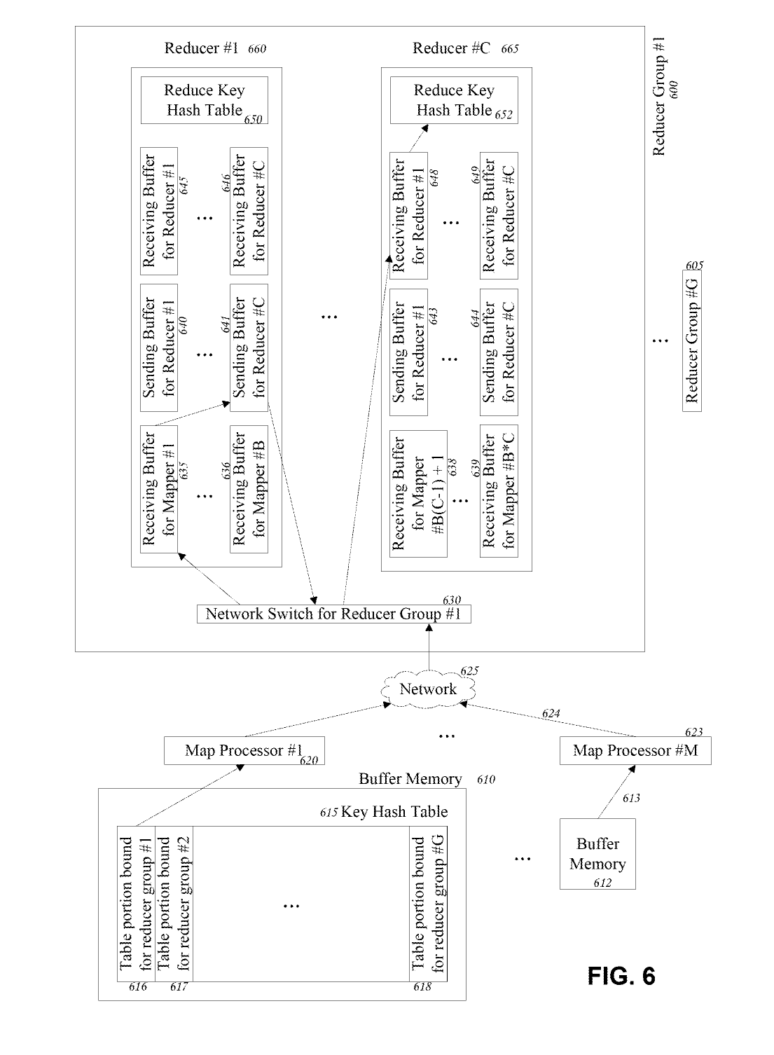

FIG. 6 depicts system components in accordance with some embodiments that may enable Mappers to use less output buffer space, and/or Reducers to use less input buffer space, than in conventional MapReduce implementations, while maintaining efficient utilization of network resources in some embodiments. Each component in FIG. 6 may be implemented in any suitable way, including as hardware, software, or a combination of hardware and software. In some embodiments, Key Hash Table 615 may be implemented in DRAM. In some embodiments, an individual Reducer may execute on a virtual server, and other Reducers may execute on other virtual servers on the same physical server, each virtual server having its own network identity and separately allocated disk and system memory. In such cases, many Reducers each implemented on a virtual server may execute on a single physical server with a multicore central processing unit. However, in some embodiments, not all Reducers in the same Reducer Group may execute on the same physical machine. In some embodiments, the Reduce Key Hash Tables and/or any of the buffers at the Reducers may be implemented via DRAM and/or SRAM, which in some embodiments may be integrated on the same silicon die as the processor core implementing the Reducer.

In the example of FIG. 6, instead of transmitting [key,value] pairs directly to the Reducer that is to carry out the Reduce operation on all values for that particular key, the [key,value] pairs can be sent to an intermediate Reducer or a different intermediate routing device that is local to the final destination Reducer. Communications may rebuffered in the intermediary Reducer, or in one or more different intermediary devices that do not perform any Reduce functions themselves.

Conventionally, partitioning of keys has been performed such that each Reducer gets a partition. Consider lightweight Mappers with limited buffer resources in a system that includes very many Reducers such as millions of servers. Conventionally, the Mapper must maintain a buffer for each Reducer and these buffers must be able to hold at least as much data as the minimum data payload that can be sent efficiently over the network. For networks such as infiniband this data payload may be around 4 kilobytes, however there are examples of larger transfer sizes of 8 kilobytes being required to achieve highest network utilization. Thus, maintaining ˜10 kB (10 kilobytes) of memory on the Mapper for each of millions of Reducers would require 10 GB of memory on the Mapper, which the inventors have recognized is a high overhead on existing systems and does not allow Mappers to be implemented at finer granularity (e.g. lower frequency 100-core processors that are more power efficient than higher frequency 10-core processors). By contrast, instead of maintaining a buffer for each Reducer on each Mapper, some embodiments as depicted in FIG. 6 may maintain data storage on each Mapper in units that serve multiple Reducers. The “Table portion bound for reducer group #1” (616), as well as the portions bound for groups #2 up to group #G (617 . . . 618) (in the case where the Reducers have been divided into G groups) may be stored in the Key Hash Table (615), which in some embodiments may be the same as the Key Hash Table (525) from FIG. 5.

In the example of FIG. 6, the Table portion bound for reducer group #1 (616) is sent from the Key Hash Table (615) (which is held in Buffer Memory 610) to the Map Processor #1 (620). This table portion contains keys bound for Reducers #1 (660) through #C (665), however they are all sent to a Reducer (or other intermediary device, in some embodiments) in Reducer Group #1 (600) that is responsible for processing messages from Map Processor #1. Load balancing of the intermediary routing operation depicted in FIG. 6 may be attained in some embodiments by having different Map Processors (620 . . . 623) send to different Reducers within a given Reducer Group, which the inventors have appreciated may be better for performance in some embodiments than the case where all Map Processors send messages to the same Reducer in a given Reducer group. In the example in FIG. 6, the Map Processor #1 (620) sends this data on to the Network (625), which communicates this data to Network Switch for Reducer Group #1 (630) which is within the Reducer Group #1.

In some embodiments, the Mapper may transmit the mapped key-value pairs collected in a buffer for a Reducer Group (e.g., buffer 616) by packaging the mapped key-value pairs into a data packet for transmission on Network 625. In some embodiments, the data packet may be sized by selecting and including a number of the mapped key-value pairs from the buffer that makes the data packet a desired size for network transmission, e.g., depending on network factors such as protocol(s) used, available bandwidth, available connections, etc. In some embodiments, the size of an individual buffer in Buffer Memory 610 for sending data to a particular Reducer Group may be established to correspond to a desired data packet size, such that the buffer may be emptied into a data packet of desired size in response to the buffer becoming full.

In some embodiments, once this communication has been sent, no additional communication to the larger network may be required to perform the final message routing. Thus the final message routing may not impose any additional burden on the Network (625) bisection bandwidth, which the inventors have appreciated may be advantageous since bisection bandwidth may cost a premium when very many Reducers are connected such as in the example depicted in FIG. 6. Local bandwidth provided by the Network Switch for Reducer Group #1 (630) may be much less expensive since this may scale linearly with the size of the network rather than by N*log(N)̂2 such as in the case that the network (625) implements a Clos topology that attempts to increase bisection bandwidth linearly with the number of nodes (N).

In some embodiments, the Reducers in a Reducer Group may be Reducers that are connected to the same Network Switch. In some other cases, a Reducer Group may be defined to include Reducers that are local to each other, e.g., in that they are able to communicate with each other with fewer intermediate network hops than is typically required for two arbitrary nodes on Network 625 to communicate. For example, in some embodiments, if half of the nodes on Network 625 require X hops to communicate with the other half of the nodes, then nodes that are able to communicate in fewer than X network hops may be considered to be local to each other. In some embodiments, nodes that are local to each other may be able to communicate with each other at higher data rate (higher bandwidth) than nodes that are not local to each other.

In the example illustrated in FIG. 6, Network Switch 630 transmits the data originating from Map Processor #1 to Reducer #1's (660) Receiving Buffer for Mapper #1 (635). In this example, Reducer #1 has multiple Receiving Buffers denoted 635 . . . 636. However, it may not have a receiving buffer for every Mapper. R Server #C (665) similarly has a set of multiple Receiving buffers 638 . . . 639. The set of Mappers that send to these buffers may not overlap with the set of Mappers that send messages to Reducer #1, in some embodiments. This carries out the load balancing effect previously described, and also decreases the number of receiving buffers each Reducer must support, in some embodiments.

In FIG. 6, [key,value] pairs are extracted individually from the data held in the Receiving Buffers (635,636,638,639) and sent to the buffer corresponding to their final destination Reducer. Thus, in some embodiments, a Reducer may receive a set of mapped [key, value] pairs from a Mapper, identify one or more [key, value] pairs in the set for whose keys that Reducer is not responsible, and transfer those [key, value] pairs to one or more other Reducers in the system. In some embodiments, a Reducer transferring [key, value] pairs to another Reducer within a Reducer Group may involve transferring [key, value] pairs between Reducers that communicate via a network, or between Reducers on different physical machines, or between Reducers on different chips, or between Reducers on different processors, or between Reducers on different processor cores, or between Reducers having access to different data storage devices and/or memory locations. In other embodiments, there may be a different intermediary device or process that receives a data packet including mapped [key, value] pairs corresponding to keys handled by multiple Reducers (e.g., the Reducers in a Reducer Group), identifies the key corresponding to each mapped [key, value] pair, identifies the Reducer responsible for that key, and provides the [key, value] pair to that Reducer for processing.

In the example depicted in FIG. 6, a [key,value] pair destined for Reducer #C (665) is sent from element 635 to element 641 within Reducer #1. This second set of buffers comprises elements 640, 641, 643, and 644. Once a sufficient number of messages have been aggregated in a buffer, they may be sent as messages through the Network Switch for Reducer Group #1 (630) to their final destination Reducer. In the example depicted in FIG. 6, the Sending Buffer for Reducer #C communicates the message received from the Receiving Buffer for Mapper #1 (635) to the Network Switch for Reducer Group #1 (630) once the buffer 641 is sufficiently full. The Network Switch for Reducer Group #1 (630) then propagates this message to the destination Reducer, which in this example is Reducer #C (665), which receives the message at Receiving Buffer for Reducer #1 (648). Units 645, 646, 648, and 649 are Receiving buffers for receiving communications from other Reducers within the same Reducer Group. Both the Sending Buffers 640 . . . 641, and 643 . . . 644, as well as these Receiving Buffers for Reducers may require only a small amount of buffer space since buffers may only be established for each Reducer in the same Reducer group. In the event that Reducer #C is Reducer 100 (i.e., C=100), then 100 Sending buffers and 100 Reducer receiving buffers may be established on each Reducer in this example.

Once the Receiving Buffer for Reducer #1 (648) of Reducer #C (665) receives the example data, it may be propagated to a Reduce Key Hash Table (652) for Reduce operations to commence. Buffer Memory (612) for other Map Processors such as Map Processor #M (623) may similarly perform operations to send mapped [key, value] pairs to intermediary devices (which may themselves be Reducers) for Reducer Groups, for subsequent Reducer-side routing of the data to the Reducers responsible for handling the associated keys. Similarly, many Reducer Groups may be supported, such as G Reducer Groups, which is depicted in FIG. 6 as the ellipsis between Reducer Group #1 (600) and Reducer Group #G (605).

In some embodiments, system components illustrated in FIGS. 1-6 and described herein may be used to run MapReduce programs prior to the user or another application requesting that they be run, to reduce or eliminate disk-based sorting in execution of the MapReduce programs, without requiring disk space on Reducers, and with reduced buffer space on both Reducers and Mappers as compared with conventional MapReduce systems. It should be appreciated as well that in various embodiments any of these potential benefits may be achieved individually or in any combination with any number of these benefits, e.g., by utilizing corresponding techniques selected from those described hereinabove.

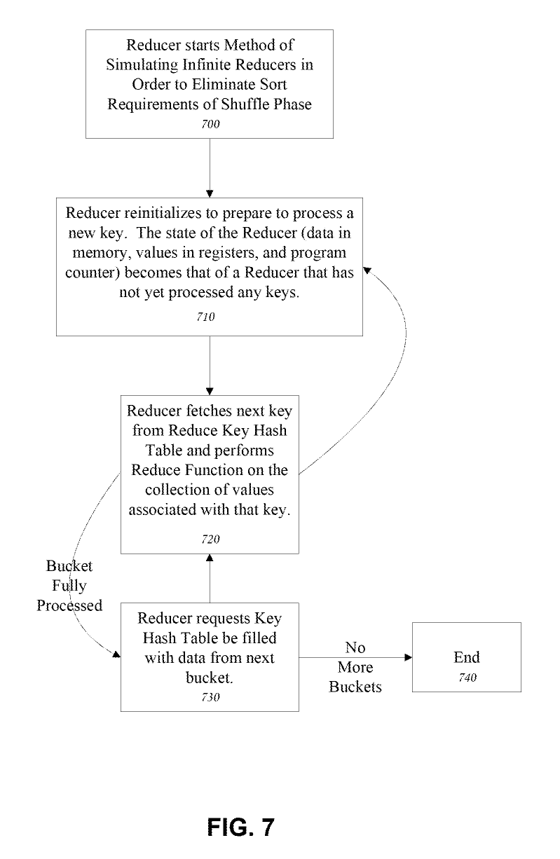

FIG. 7 depicts an exemplary method that may be performed by a Reducer in some embodiments to process keys in sorted order without requiring a shuffle phase to perform sorting. Some embodiments may simulate an infinite number of Reducers by processing each key within a MapReduce program with an initialized (or reinitialized) state. In a system with truly infinite Reducers the Reducers that do not receive any keys would perform no operations and thus the inventors have appreciated that simulating only those Reducers that receive keys may allow for an effective simulation of an infinite number of Reducers in some embodiments.

Step 700 begins the process depicted in FIG. 7. In Step 710 the process initializes the state of the Reducer including its memory, register values, and program counter (current location within the Reduce function) so initially the Reducer assumes a state in which it has not yet processed any keys or values. This may be performed, in some embodiments, by creating a new process from scratch or by maintaining a copy of the Reducer State just prior to the Reducer accessing the input key or any input value and then recopying that state over the current Reducer Thread State. In the case that this is not the first initialization of the Reducer the initialization is said to be a reinitialization. Step 710 proceeds to Step 720.

In Step 720 the Reducer function receives a previously unprocessed key from the Reduce Key Hash Table (650, 652) as input and processes the values associated with the input key. If this key is the last unprocessed key assigned to the Reducer in the current bucket that has not yet been processed then the Reducer requests that the Reduce Key Hash Table (650, 652) be filled with keys and values from the next bucket that has not yet been processed in step 730. Otherwise Step 720 proceeds back to Step 710.

If Step 730 finds that all buckets have been processed then the process proceeds to Step 740 and ends, otherwise the process proceeds back to Step 720.

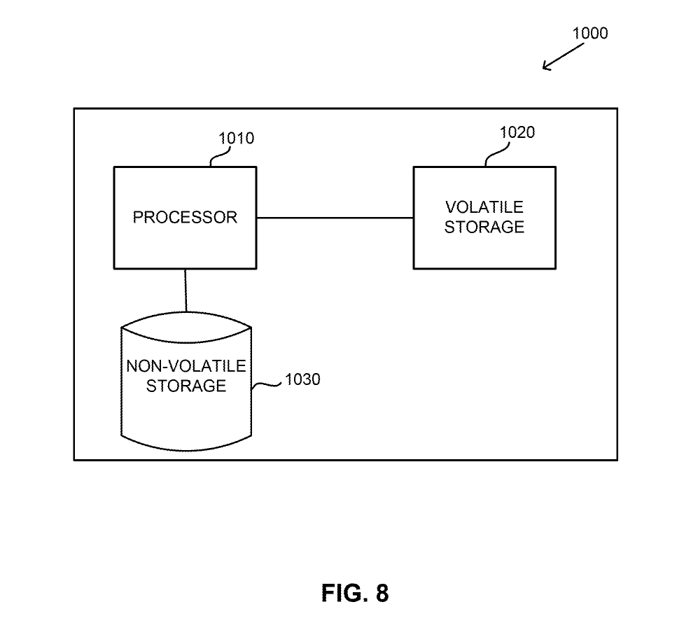

An illustrative implementation of a computer system 1000 that may be used in connection with some embodiments of the present invention is shown in FIG. 8. One or more computer systems such as computer system 1000 may be used to implement any of the functionality described above. The computer system 1000 may include one or more processors 1010 and one or more computer-readable storage media (i.e., tangible, non-transitory computer-readable media), e.g., volatile storage 1020 and one or more non-volatile storage media 1030, which may be formed of any suitable volatile and non-volatile data storage media, respectively. The processor 1010 may control writing data to and reading data from the volatile storage 1020 and/or the non-volatile storage device 1030 in any suitable manner, as embodiments are not limited in this respect. To perform any of the functionality described herein, processor 1010 may execute one or more instructions stored in one or more computer-readable storage media (e.g., volatile storage 1020 and/or non-volatile storage 1030), which may serve as tangible, non-transitory computer-readable media storing instructions for execution by the processor 1010.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of embodiments of the present invention comprises at least one processor-readable storage medium (i.e., at least one tangible, non-transitory processor-readable medium, e.g., a computer memory (e.g., hard drive, flash memory, processor working memory, etc.), a floppy disk, an optical disc, a magnetic tape, or other tangible, non-transitory processor-readable medium) encoded with a computer program (i.e., a plurality of instructions), which, when executed on one or more processors, performs above-discussed functions of embodiments of the present invention. The processor-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. Apparatus comprising:
a processor configured to function as at least a Mapper in a MapReduce system; and
a processor-readable storage medium storing processor-executable instructions that, when executed by the processor, cause the processor to perform a method comprising:
generating a set of [key, value] pairs by executing a Map function on input data; and
storing the set of [key, value] pairs in a storage system implemented on at least one data storage medium, the storage system being organized into a plurality of divisions with different divisions of the storage system storing [key, value] pairs corresponding to different keys, the storing comprising storing in a first division of the plurality of divisions both a first [key, value] pair corresponding to a first key handled by a first Reducer in the MapReduce system and a second [key, value] pair corresponding to a second key handled by a second Reducer in the MapReduce system.

2. The apparatus of claim 1, wherein storing the set of [key, value] pairs in the storage system comprises distributing the [key, value] pairs across the plurality of divisions of the storage system such that a number of Reducers handling keys corresponding to [key, value] pairs stored together in a division of the storage system is maximized.

3. The apparatus of claim 1, wherein the method further comprises:
retrieving the [key, value] pairs stored in the first division of the storage system;
transferring the first [key, value] pair retrieved from the first division to the first Reducer responsible for the first key, together with other [key, value] pairs retrieved from the first division that correspond to the first key; and
transferring the second [key, value] pair retrieved from the first division to the second Reducer responsible for the second key, together with other [key, value] pairs retrieved from the first division that correspond to the second key.

4. The apparatus of claim 1, wherein storing the set of [key, value] pairs in the storage system comprises:
collecting at least some [key, value] pairs of the set of [key, value] pairs in a first storage system implemented on at least one volatile storage medium, the first storage system being organized into a plurality of buffers, the collecting comprising collecting the first [key, value] pair and the second [key, value] pair in a first buffer of the plurality of buffers; and
moving the at least some [key, value] pairs from the first storage system to a second storage system implemented on at least one non-volatile storage medium, the second storage system being organized into the plurality of divisions, the moving comprising moving the first [key, value] pair and the second [key, value] pair from the first buffer of the first storage system to the first division of the second storage system.

5. The apparatus of claim 4, wherein the at least one volatile storage medium comprises dynamic random-access memory (DRAM).

6. The apparatus of claim 4, wherein the method further comprises establishing a size of the first buffer in the first storage system such that when data filling the first buffer is moved to the first division of the second storage system, a seek time and a write time for the at least one non-volatile storage medium of the second storage system are balanced.

7. The apparatus of claim 4, wherein the method further comprises establishing a size of the first division of the second storage system to not exceed a size capacity of the first storage system.

8. The apparatus of claim 4, wherein moving the at least some [key, value] pairs from the first storage system to the second storage system further comprises, in response to a first buffer in the first storage system being emptied by moving all [key, value] pairs in the first buffer to the second storage system:
identifying a second buffer of the plurality of buffers that is most full in the first storage system; and
beginning a process of emptying the second buffer by moving [key, value] pairs in the second buffer to the second storage system.

9. A method comprising:
generating, via a processor configured to function as at least a Mapper in a MapReduce system, a set of [key, value] pairs by executing a Map function on input data; and
storing the set of [key, value] pairs in a storage system implemented on at least one data storage medium, the storage system being organized into a plurality of divisions with different divisions of the storage system storing [key, value] pairs corresponding to different keys, the storing comprising storing in a first division of the plurality of divisions both a first [key, value] pair corresponding to a first key handled by a first Reducer in the MapReduce system and a second [key, value] pair corresponding to a second key handled by a second Reducer in the MapReduce system.

10. The method of claim 9, wherein storing the set of [key, value] pairs in the storage system comprises distributing the [key, value] pairs across the plurality of divisions of the storage system such that a number of Reducers handling keys corresponding to [key, value] pairs stored together in a division of the storage system is maximized.

11. The method of claim 9, further comprising:
retrieving the [key, value] pairs stored in the first division of the storage system;
transferring the first [key, value] pair retrieved from the first division to the first Reducer responsible for the first key, together with other [key, value] pairs retrieved from the first division that correspond to the first key; and
transferring the second [key, value] pair retrieved from the first division to the second Reducer responsible for the second key, together with other [key, value] pairs retrieved from the first division that correspond to the second key.

12. The method of claim 9, wherein storing the set of [key, value] pairs in the storage system comprises:
collecting at least some [key, value] pairs of the set of [key, value] pairs in a first storage system implemented on at least one volatile storage medium, the first storage system being organized into a plurality of buffers, the collecting comprising collecting the first [key, value] pair and the second [key, value] pair in a first buffer of the plurality of buffers; and
moving the at least some [key, value] pairs from the first storage system to a second storage system implemented on at least one non-volatile storage medium, the second storage system being organized into the plurality of divisions, the moving comprising moving the first [key, value] pair and the second [key, value] pair from the first buffer of the first storage system to the first division of the second storage system.

13. The method of claim 12, wherein the at least one volatile storage medium comprises dynamic random-access memory (DRAM).

14. The method of claim 12, further comprising establishing a size of the first buffer in the first storage system such that when data filling the first buffer is moved to the first division of the second storage system, a seek time and a write time for the at least one non-volatile storage medium of the second storage system are balanced.

15. The method of claim 12, further comprising establishing a size of the first division of the second storage system to not exceed a size capacity of the first storage system.

16. The method of claim 12, wherein moving the at least some [key, value] pairs from the first storage system to the second storage system further comprises, in response to a first buffer in the first storage system being emptied by moving all [key, value] pairs in the first buffer to the second storage system:
identifying a second buffer of the plurality of buffers that is most full in the first storage system; and
beginning a process of emptying the second buffer by moving [key, value] pairs in the second buffer to the second storage system.

17. At least one processor-readable storage medium storing processor-executable instructions that, when executed by a processor configured to function as at least a Mapper in a MapReduce system, perform a method comprising:
generating a set of [key, value] pairs by executing a Map function on input data; and
storing the set of [key, value] pairs in a storage system implemented on at least one data storage medium, the storage system being organized into a plurality of divisions with different divisions of the storage system storing [key, value] pairs corresponding to different keys, the storing comprising storing in a first division of the plurality of divisions both a first [key, value] pair corresponding to a first key handled by a first Reducer in the MapReduce system and a second [key, value] pair corresponding to a second key handled by a second Reducer in the MapReduce system.

18. The at least one processor-readable storage medium of claim 17, wherein storing the set of [key, value] pairs in the storage system comprises distributing the [key, value] pairs across the plurality of divisions of the storage system such that a number of Reducers handling keys corresponding to [key, value] pairs stored together in a division of the storage system is maximized.

19. The at least one processor-readable storage medium of claim 17, wherein the method further comprises:
retrieving the [key, value] pairs stored in the first division of the storage system;
transferring the first [key, value] pair retrieved from the first division to the first Reducer responsible for the first key, together with other [key, value] pairs retrieved from the first division that correspond to the first key; and
transferring the second [key, value] pair retrieved from the first division to the second Reducer responsible for the second key, together with other [key, value] pairs retrieved from the first division that correspond to the second key.

20. The at least one processor-readable storage medium of claim 17, wherein storing the set of [key, value] pairs in the storage system comprises:
collecting at least some [key, value] pairs of the set of [key, value] pairs in a first storage system implemented on at least one volatile storage medium, the first storage system being organized into a plurality of buffers, the collecting comprising collecting the first [key, value] pair and the second [key, value] pair in a first buffer of the plurality of buffers; and
moving the at least some [key, value] pairs from the first storage system to a second storage system implemented on at least one non-volatile storage medium, the second storage system being organized into the plurality of divisions, the moving comprising moving the first [key, value] pair and the second [key, value] pair from the first buffer of the first storage system to the first division of the second storage system.

21. The at least one processor-readable storage medium of claim 20, wherein the at least one volatile storage medium comprises dynamic random-access memory (DRAM).

22. The at least one processor-readable storage medium of claim 20, wherein the method further comprises establishing a size of the first buffer in the first storage system such that when data filling the first buffer is moved to the first division of the second storage system, a seek time and a write time for the at least one non-volatile storage medium of the second storage system are balanced.

23. The at least one processor-readable storage medium of claim 20, wherein the method further comprises establishing a size of the first division of the second storage system to not exceed a size capacity of the first storage system.

24. The at least one processor-readable storage medium of claim 20, wherein moving the at least some [key, value] pairs from the first storage system to the second storage system further comprises, in response to a first buffer in the first storage system being emptied by moving all [key, value] pairs in the first buffer to the second storage system:
identifying a second buffer of the plurality of buffers that is most full in the first storage system; and
beginning a process of emptying the second buffer by moving [key, value] pairs in the second buffer to the second storage system.
